(19) United States
(12) Patent Application Publication
(10) Pub. No.: US 2003/0100315 A1
(43) Pub. Date: May 29, 2003

(54) Location based delivery of service data

(75) Inventor: Paul J. Rankin, Horley (GB)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS

(21) Appl. No.: 10/299,277

(22) Filed: Nov. 19, 2002

(30) Foreign Application Priority Data
Nov. 24, 2001 (GB) 0128220.1

(51) Int. Cl. H04Q 7/20

(52) U.S. Cl. 455/456

(57) ABSTRACT

A method and apparatus are provided for the delivery of service data (64) to the user (40) of a handset or other portable communications device (42). The user carries the handset (42) and a trigger device (44) having an RF-discoverable identity. The trigger device identity is registered (58) at a service provider (54-60), together with a connection address for the handset and, optionally, interest profile data for that user (40). A network of detector devices (48) is arranged to detect the trigger device identity and to report with identification of the users location to the service provider, which selectively delivers service data (64) to the users handset (42) in dependence on the users location and their stored interest profile data. The service data (64) includes incentives to the user for using the system, with those incentives relating to, and being paid for by, locations hosting one or more of the detector devices (48).

The present invention relates to the delivery of service data, including advertisements and customer incentives, to users of portable communications devices. In particular, although not exclusively, the invention relates to the supply of such data to users of devices such as mobile phones or pagers via existing wide-area network connections.

Among the group of potential service data providers, retailers would like to increase the motivation for purchase while potential customers are close by and aroused by visual and other advertising media, while users would like to receive discount for their custom and receive more personalized offers which are relevant to the place they are in. Mailshots of paper coupons or tokens for redeeming by customers in retail outlets are one known method for increasing customer motivation. These have a lower value, however, as they are delivered out of context—that is to say the user is required to collect and carry the coupons and remember to use them when they are next visiting the retail outlet which issued them. Known technical solutions tend to be either handset-specific (requiring specially-enabled personal digital assistant PDA devices or telephones) or are limited to one particular RF (radio frequency) or IR (infra red) short-range technology and specifically-built handsets that support them (involving sophisticated Bluetooth protocols and the like).

One example requiring special-purpose, expensive PDA's which can sense RF beacons, or GPS-enabled handsets, which can activate location-based services, including pushed offers, is described in “Using and Determining Location in a Context-Sensitive Tour Guide” by N. Davies et al, IEEE Computer, August 2001, pp.35-41. Another known arrangement is AT&T's ‘Active badge’ system, as described in “Implementing a Sentient Control System” by M. Addlesee et al, IEEE Computer, August 2001, pp.50-56. In this system designed for use in offices, special-purpose wireless devices (known as ‘Bats’) with unique ID's are carried by users and offer simple 2-button functionality. These Bats are very accurately located in a building by a sophisticated (expensive) ultrasonic beacon infrastructure and wireless back channel, allowing a variety of push and pull location-based services at work.

Among known efforts to provide services to users of portable communications devices, the Streetbeam system (www.streetbeam.com viewed Nov. 23, 2001) provides electronic advertising ‘kiosks’ in New York attached to billboards or shop displays. Infra-red (irDA) beacons deliver store adverts and offers to passing Palm PDA's and WAP-enabled phones: the latter requires the manual entry of the kiosk number, but kiosks can be bookmarked. In another example, the ZagMe system has services or coupons sent to mobile phones in dependence on the users location as determined by the mobile cell ID or by the user explicitly declaring their location. In use, users phone in to register with the service provider, activate the service when they enter a shopping mall, then receive text-message offers and ‘ZagPoints’ (coupons), for exchange in a store or as pre-pay phone vouchers.

Generally, handset interoperability limitations mean that the introduction of a mass-used system is hampered either by the beacon infrastructure installation costs, or the need for a critical mass of users with specially-enabled handsets who will receive enough offers to attract advertiser investment. Different short-range RF or IR technologies for enabling such systems are preferable for different locations or regions, either on commercial grounds (such as market penetration/acceptance or cost), or due to features of the locale (street canyons, visibility of satellites for discovery, interference, multiple reflections and so forth). From an application-provider's or advertiser's view, they would like the largest consumer coverage (handset interoperability) and a service-provision system which is independent of the details of the short-range RF or IR technology deployed in different places/regions, or the market shares of different handset makers.

It is accordingly an object of the present invention to provide a method for the delivery of service data to users of portable communications devices which does not require a large initial investment in a dedicated communications infrastructure by service providers, nor (necessarily) the purchase of special or customised communications devices by users.

In accordance with the present invention there is provided a method for the delivery of service data to the user of a portable communications device: wherein the user carries said portable communications device and a trigger device having a wireless-discoverable identity; wherein the trigger device identity is registered at a service provider, together with a connection address for the portable communications device of that user; wherein a distributed arrangement of detector devices is arranged to detect the trigger device identity and to report with identification of the trigger device location to the service provider; and wherein the service provider selectively delivers service data to the portable communications device of the user, with the selection being made at least partially in dependence on the users location.

By the use of a trigger device, which is preferably a simple wireless-discoverable device that may be produced and distributed cheaply, users are encouraged to participate in a scheme which is able to provide them with targeted offers and services via their existing mobile phone or like device.

To enhance the selection of service data delivered, user profile information for a user may be stored by the service provider with the trigger device identity for that user, with the selection of delivered service data being made partially in dependence on said stored user profile information (i.e. in addition to dependence on the users location). Such stored user profile information may include calendar information for the user, with the selection of delivered service data made partially in dependence on this stored calendar information and the time and/or date at which the trigger device identity is reported to the service provider: as an example, if the users calendar information indicates that they only visit a given location in the afternoon, the profile reference would stop details of a discount on breakfasts at a restaurant in that location being sent to the user when passing, as such an offer would be unlikely to be taken up by the user.

At least one detector device may be located in the vicinity of a retail outlet and, on the detection of a trigger device by that detector device, the service data selected for delivery may comprise data relating to goods or services available from the retail outlet, particularly special offers. In such a vendor-specific arrangement, the retail outlet may pay the service provider for passing on data relating to their goods or services. As another user incentive, the service data selected for delivery may include a coupon exchangeable by the user, in whole or in part, for goods or services from the retail outlet: such a coupon may be in the form of an identifier code to be quoted by the user and recognised by the retail outlet as a pre-condition for the user obtaining the free goods or discount.

The service provider may provide periodic inducements-to-use to a user, the cost of which inducements may or may not be passed on to the retail outlets or others whose service data is delivered. Such periodic inducements-to-use may comprise periods of free connection time for the users portable communications device to encourage them to keep the device switched on and ready to receive service data.

To avoid annoying the user by repeatedly sending the same data, or to prevent users from gathering an excess of service data items such as discount coupons from a single retail outlet, the service provider may maintain a record of service data delivered to a user at a detected location and, on detecting that user at the same location subsequently, may deliver only service data that has not previously been delivered.

In order to further refine the targeting of goods and/or service offers to a user, the delivered service data may include an identifier for the content thereof, with the users portable communications device being configured (optionally by the user) to filter the service data on receipt and accept or reject it on the basis of the content thereof. The filtering may be at a detailed level including some form of subject matter classification for messages, or it may be cruder and be based on the content identifier comprising an identifier for the service provider delivering the data, with the accept/reject decision being based purely on the service provider identity.

Recognising that the user will not always be able to receive service data when the trigger device is detected (they may be taking a telephone call at the time, for example), the service provider may further store a second connection address, for a further communications device of the user, with the service data being instead delivered to this further communications device if the service provider is unable to deliver it to the users portable communications device. Given the increasing prevalence of internet-enabled home computers, the second connection address may be an e-mail address for the user, with service data being sent to the alternative destination for later consideration by the user.

Also in accordance with the present invention there is provided apparatus for the delivery of service data to the user of a portable communications device, comprising: said portable communications device to be carried by said user; a trigger device having a wireless-discoverable identity and also to be carried by said user; a service provider data storage and retrieval system including a store of service data and communications means operable to connect to said portable communications device, wherein said trigger device identity is registered at a service provider, together with a connection address for the portable communications device of that user; and a distributed arrangement of detector devices operable to communicate with said service provider data storage and retrieval system, arranged to detect trigger device identities and to report with identification of the trigger device location to the service provider system, wherein said service provider system is arranged to select from store and deliver service data to the portable communications device of the user, with the selection being made at least partially in dependence on the users location. The detector devices are suitably connected to the service provider system via a data or communications network, such as an existing telecommunications network, the internet, or a dedicated data link.

The service provider may be operable to deliver data to a users portable communications device in two or more forms, with the form for delivery being selected in dependence on the users location as determined by the detector device detecting the users trigger device: for example, where the detector device is in a noisy location (such as a retail outlet on a busy street), or one where silence must be maintained (such as a theatre), the data may be delivered as a text message, whereas other locations may trigger the delivery of an audio message to the user.

Further in accordance with the present invention there is provided a trigger device for use as a part of the apparatus recited above, including storage means holding a unique identifier and being configured for wireless discovery of said identifier by the said detector devices. Such a trigger device may include a short range RF transmitter and receiver and be configured to transmit the stored identifier on receipt of a predetermined signal from a detector device, or it may include an infra-red communications facility and be operable to transmit the stored identifier via infra-red link to a suitable receiver on a detector device, or it may be configured as a swipe card, with one or more detector devices having a suitably configured card reader, and with the stored identifier being passed to a detector device on swiping of the card through that detector devices card reader.

Given that a users interests will vary depending on whether, for example, they are working or at leisure, a user may have different trigger devices to be carried in dependence on the current context. Alternatively, in a single trigger device, the storage means may hold two or more unique identifiers and further comprise user operable means for selectively enabling or disabling discovery of each stored identifier by a detector device.

In a further embodiment, to accommodate mobile detector devices without means for position determination, a trigger device according to the present invention may further comprise position determining means operable to determine a current location for the trigger device and to pass information identifying the same to a detector device discovering the or each unique stored identifier for that trigger device.

Still further in accordance with the present invention there is provided a portable communications device for use as a part of the apparatus recited above, and having integral therewith a trigger device as further recited. Such a portable communications device may further comprise position determining means operable to determine a location for the portable device, wherein the discovery of the unique identifier includes capture of the portable device determined location by the detector device.

Further features and advantages of the present invention will become apparent from reading of the following description of embodiments of the present invention, given by way of example only, with reference to the accompanying drawings, in which:

FIG. 1 schematically represents the flow of data, income and incentives in a system embodying the present invention;

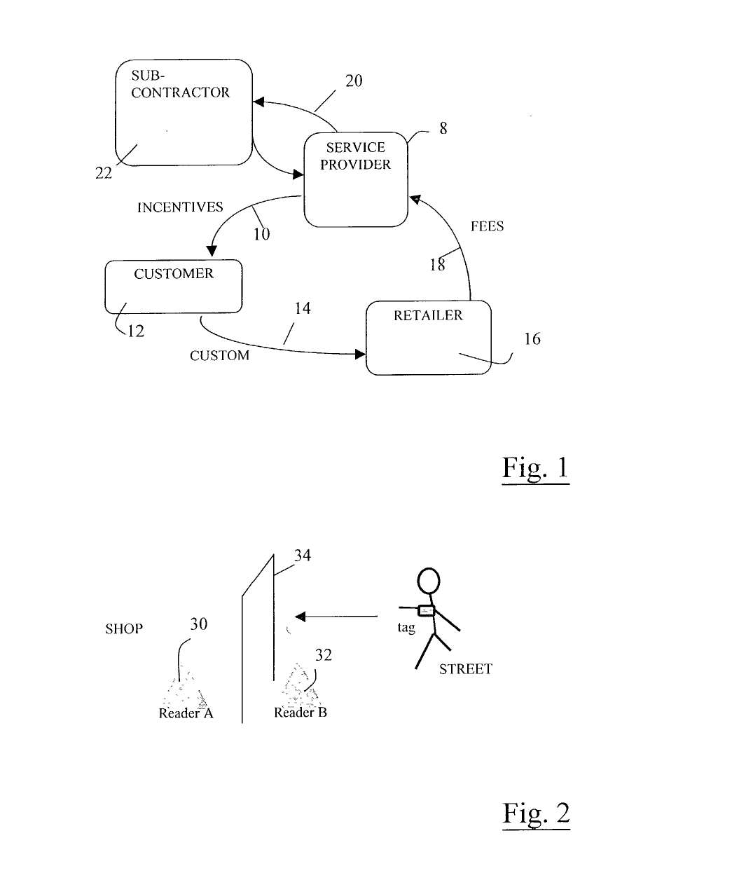

FIG. 2 represents a mechanism for activating and deactivating the delivery of service date as a user enters a building; and

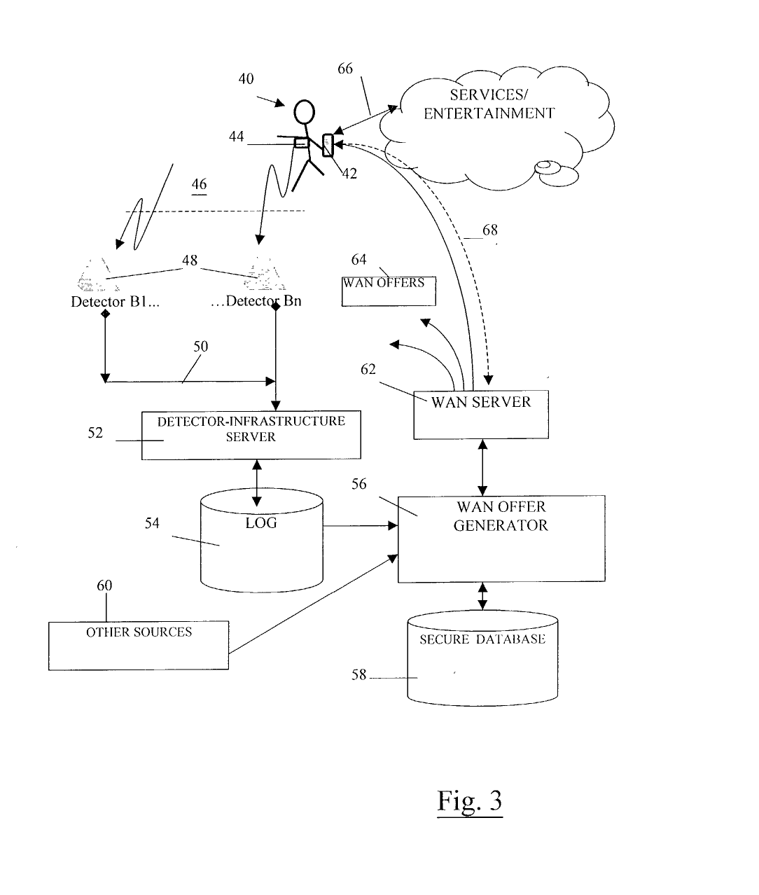

FIG. 3 is a general schematic of apparatus configured according to an embodiment of the invention.

Referring initially to FIG. 1, a method is provided for delivery 10 of service data (including advertisements, electronic coupons and the like) from a communications service provider 8 to a customer 12 via a portable communications device of that user, such as to persuade the customer to visit 14 a retail outlet or other service provider 16. In return for the delivery of service data about a particular retailers goods or services, that retailer pays a fee 18 to the communications service provider 8. As shown, the communications service provider 8 may subcontract 20 another party 22 to handle additional features (to be discussed) such as user profiling, the creation of alert messages, and the provision of infrastructure components. The method can run as one system with a wide variety of existing communications handsets and with minimal RF complexity or beacon infrastructure.

In its simplest form, customers are provided with wireless discoverable tags which act as locators for wide-area network offers and service connections. Users register with a service (eg via Internet web site or phone call) and provide the following information:

their unique (RF or IR-discoverable) tag or other trigger-device ID number, along with

one or more corresponding wide-area network (WAN) addresses of their communication handsets, e.g. pager or instant messaging device number or mobile phone number. Alternatively the return path to the user's handset may be via wireless local area network (LAN) such as to an 802.11 network address or internet portal address for a personal digital assistant (PDA) device or the like. It should be noted that it is assumed throughout the following description that WAN message/offer generation and interaction may alternatively be via wireless LAN.

optionally one or more interest profiles—possibly linked to personal calendar or time-event rules, as discussed in greater detail below.

For this type of service to be acceptable to users, the operators of the detector network and WAN profiled message generation system must be bound by consistent, declared privacy policies, covering the sharing of any personal or location data with other parties, outlining the provisions for subpoena etc. It should be noted that the location or identities of specific users do not need to be disclosed to the end-retailer or location-specific service provider before the user follows up by using any Internet or WAN pointers embedded in a WAN offer. The owner of any registered WAN address is of course the person entitled to de-register that device (address) from the service, as may be required on mislaying their trigger device for example.

On coming within range of RF detectors/beacons/access points doing trigger-device detection, the detector back-channel to a central message server activates the emission of WAN service data (“offers”), for example text SMS messages, phone calls, push WML cards, and similar back to the user's registered WAN address for their handset. These WAN offers may be in addition be echoed to other user addresses, for example e-mailed to the user's Internet address, so that a log of offers can be subsequently examined by the busy user. Either the user or the constraints of a detector's locale might restrict the total number of offers or rate at which WAN offers are generated. In an extension, a user may see only new WAN offers that they have not previously been sent to them when they return to a locale.

The trigger device may be embedded as part of the communication handset, or effected via a handset accessory (such as a Bluetooth wireless headset, or Bluetooth battery pack unit), or supplied specially for the purpose of accurate-location detection for these services (for example an RFID tag or pocket Zigbee device and battery pack). The trigger device may be continuously discoverable, or have a simple switch for the owner to turn its discoverability on/off (thus starting/stopping the generation of located WAN messages), or even have a control to re-set the ID that detectors discover, so that a different user profile of preferences is activated for the WAN offer generation. The aim of the communications service provider (8; FIG. 1) is as advertising agency providing incentives for users to leave their trigger device in a discoverable mode, for example to collect e-coupons or discount tokens which can be redeemed for discounts from the retailer, free talk time from the network operator, prizes for participation in located social gaming, and so on. Other location-based information services may be directly charged to the user.

It will be noted that these pushed information offers, possibly with their attached e-coupon incentives, are selected by a central server to match the detected user's registered preferences and calendar and detected location. Alternatively, or additionally, filtering of the WAN offers/messages can be done on the handset by selecting or deselecting a caller ID group, by detection of classifications attached to the WAN offers (‘restaurant’, ‘hotel’ etc): using the WAP facilities in UAPROF, for example, can be set to filter pushed WML cards.

Many types of user-registered located services are then possible, some using the current user's location, and some their most recently-detected location. These services include advertising offers (perhaps accompanied by token codes or e-coupons which can be exchanged for retailer discounts or free phone talk-time), proximity alerts of nearby friends, located messages to others users, personal information on travel timetables, product information, and so forth.

A variety of trigger-detection methods may be supported by the same basic service machinery owned by the provider/advertiser, thus offering a large critical mass of potential customers and a business growth path for a business owner, such as an advertising company. A number of such detection methods will now be described.

One or more RF ID tags may be given away free to customers on registration. One user may carry different unique tags for different occasions, for example a blue-coloured one for shopping, a red one for socializing with friends, a green one for visiting a new town. Each of these tags would activate different interest profile sets. These tags may optionally be attached to the mobile handset, such as by means of a clip or Velcro so that the user does not forget to take one or the other. The detectors for such devices suitably have about a 1-2 m range, so would be deployed in places where the customer's passage is restricted, such as by the doors of shops, next to ride queues in theme parks, beside specific product placements in shops, at cash registers, at tables in a bar, and so on.

Another method has Bluetooth, Zigbee (802.15.4) or similar RF access points/beacons performing periodic or continuous device inquiry with a range of about 10 m. The user's trigger device may be a wireless headset, mobile phone, or PDA, or perhaps a dedicated RF unit giving the trigger function (either with its own battery or plugging into the handset's power supply as an accessory). Using Bluetooth, the trigger device only needs to be able to be set into the Bluetooth general ‘discoverable’ mode. Note with Bluetooth that setting ‘discoverability’ as a mode in the General Access Profile (GAP) is separate to setting connectability: on an Ericsson T39 phone, for example, these are separately controllable modes. The GAP is used by other higher-level Bluetooth profiles, such as that for hands-free headsets. The latter defines that the profile for headset use must support both discoverability (for the initial mating with a handset) and non-discoverability (for privacy). With Zigbee, various arrangements are possible, including ones where the trigger device is treated either as a master or a slave, as will be understood.

Alternatively, the detection of the user's presence in a locale may be via the act of a handset's establishment of a network connection to a wireless RF LAN (such as 802.11b locating the user to a coarser level of resolution, say +/−100 m)

Detection may involve access to user's (assisted) GPS location data, periodically reported (with user consent) to the centre, for comparison with defined logical regions on a map, which regions have specific areas of interest matching the user's (current) profile. Alternatively, it may involve access to handset location data gathered by infrastructure deployed by the mobile network operator (such as E-OTD, GPRS), for example to satisfy E911 regulations in the USA.

Other detection methods may include IR detection, where the consenting user deliberately signals a located irDA reader with a unique code from their PDA or other IR enabled device. The system might even be unified with loyalty/credit card use as the location trigger, if the user consents to transaction log sharing with their credit card/loyalty card operator.

The detector devices are expected usually to be deployed in fixed known positions that are ‘hotspots’ of social or commercial activity. However, the placement of detectors in passenger vehicles is also possible.

After detection of a user's trigger device, the device ID is passed (as rapidly as possible), with the detector's ID over a back-end infrastructure to the central server (service provider). There, the detector's ID is mapped to a logical location and related set of information, services and products, taking into account the known range and latency of that detector's technology and back-end path. WAN offers are then generated (for example in XML), optionally using the registered user's stored currently-active profile, rendered for the specific screen characteristics or other functional requirements of the user's communication handset (for example selecting between SMS text message, visual icon, audio etc.). The modality of the WAN offer may take into account the detector's position and handset characteristics—for example silent text messages may be preferred in a museum or in a noisy disco. The WAN offers may themselves contain other WAN pointers or addresses, so that the connection from the handset, for example to a 1-800 number to hear a voice recording or to a WAP site for follow-up interaction, is made easy for the user.

The generation of WAN offers may be terminated by different schemes, for example stopping after a defined time such as 5 minutes after the detection, or manually by a (pre-coded) WAN signal from the user's handset. For some shorter-range detection technologies, means can be provided to automatically start/stop the WAN offer generation on entry/exit to locales. For example, with RFID tags, as shown by FIG. 2, a pair of tag readers 30, 32 might be placed at chest height, one on the outside of a doorframe 34, one on the inside, so that an incoming tag detected by reader B 32 then reader A 30 activates WAN shop offers, whilst the reverse sequence de-activates the WAN offers. Similar means might be used with Bluetooth beacons at each end of a corridor or theme-park queue.

The owner of the deployed system may offer an easy way for retailers or located-service providers to provide and update their WAN offers. This may be a web site that registered retailers can access to update the links embedded in WAN offers associated with numbered trigger detectors allocated to their premises. Alternatively, there may be automatic links into, for example, supermarket shelf inventories.

FIG. 3 is a general schematic of the system architecture for providing service data to a customer 40 carrying both a handset 42 and a trigger device 44. In principle any handset supporting WAN (1G, 2G, 3G) or wireless LAN communication (802.11b etc) can be supported. The trigger device 44 performs short range IR or RF exchanges (illustrated generally at 46) with one or more fixed detector devices 48. Over a permanent or intermittent back end link 50, a detected trigger device ID is passed to a detector infrastructure server 52. This information is placed in a secure log 54 for subsequent processing by a central WAN offer generator 56.

The WAN offer generator 56 has access to a secure database 58 of registered user data including WAN addresses and trigger device ID's, as well as user interest profiles and service provider preferences as discussed above. Other sources of location data, indicated generally at 60, may be provided where the trigger device ID's are detected by detector devices not having a known location, for example mobile detectors. As described previously, such location information may comprise mobile network cell ID's, GPS data, user input co-ordinates and so on.

The WAN offer generator 56 generates the appropriate service data/offers and passes them to a device-dependent instant messaging WAN server 62 which creates the WAN offers (illustrated generally at 64) and transmits them to the users handset 42. As previously mentioned, the WAN offers may include WAN addresses to allow the user to conduct a follow up interaction with located services or entertainment 66, to obtain further product information, or to carry out (secure) transactions. As shown by dashed line 68, the user may control the process by switching on/off the delivery of WAN offers, or by switching from one stored profile to another.

In addition to the range of handset 42 types and configurations, a wide variety of users' RF trigger devices 44 can also be supported. These devices do not need to be set up to handle any complex RF interaction or protocols, other than periodically supporting (preferably user-controllable) discoverability —note that RF connectability is not required. The RF trigger may be a separate device from the user's mobile phone (eg. a Bluetooth headset, or an RFID badge in jewelry or in a keyring which is supplied free to the user by the advertising agency on service registration). The trigger may thus be discovered at shop entrance doors, near retail product placements at cash registers or other points. Multiple RF and IR trigger, including Zigbee, 802.11, Bluetooth, irDA technologies are supportable by the same service engine.

Different back-end networks 50 behind the detectors/beacons and linking them to the central personal, location-specific message server 52 are possible, such as X10, GSM/GPRS, wired or wireless LAN, and 802.11, amongst others. Existing back-end network infrastructures may also be employed, such as those to in-store cash registers or credit card points.

The system is applicable to shopping malls, theme parks, places of social entertainment, museums, offices, closed environments of any kind, enterprise locales, homes and, in fact, anywhere where knowledge of the user's location can contextualize wide-area communication and service activation.

From reading the present disclosure, other variations will be apparent to persons skilled in the art. Such variations may involve other features which are already known in the methods and apparatuses for delivery of service data to users of portable communications devices, and component parts thereof and which may be used instead of or in addition to features already described herein.

1. A method for the delivery of service data to the user of a portable communications device:
wherein the user carries said portable communications device and a trigger device having a wireless-discoverable identity;
wherein the trigger device identity is registered at a service provider, together with a connection address for the portable communications device of that user;
wherein a distributed arrangement of detector devices is arranged to detect the trigger device identity and to report with identification of the trigger device location to the service provider; and
wherein the service provider selectively delivers service data to the portable communications device of the user, with the selection being made at least partially in dependence on the users location.

2. A method as claimed in claim 1, wherein user profile information for a user is stored by the service provider with the trigger device identity for that user, with the selection of delivered service data being made partially in dependence on said stored user profile information.

3. A method as claimed in claim 2, wherein said stored user profile information includes calendar information for the user and the selection of delivered service data is made partially in dependence on said calendar information and the time and/or date at which the trigger device identity is reported to the service provider.

4. A method as claimed in claim 1, wherein at least one detector device is located in the vicinity of a retail outlet and, on the detection of a trigger device by said detector device, the service data selected for delivery comprises data relating to goods or services available from said retail outlet.

5. A method as claimed in claim 4, wherein said retail outlet pays the service provider for passing on said data relating to goods or services available.

6. A method as claimed in claim 4, wherein said service data selected for delivery includes a coupon exchangeable by the user, in whole or in part, for goods or services from said retail outlet.

7. A method as claimed in claim 6, wherein said coupon is in the form of an identifier code to be quoted by the user and recognised by the retail outlet.

8. A method as claimed in claim 1, wherein the service provider provides periodic inducements-to-use to a user.

9. A method as claimed in claim 8, wherein said periodic inducements-to-use comprise periods of free connection time for said portable communications device.

10. A method as claimed in claim 1, wherein the service provider maintains a record of service data delivered to a user at a detected location and, on detecting said user at the same location subsequently, delivers only service data that has not previously been delivered.

11. A method as claimed in claim 1, wherein the delivered service data includes an identifier for the content thereof, and the users portable communications device is configured to filter said service data on receipt and accept or reject it on the basis of the content thereof.

12. A method as claimed in claim 11, wherein the said content identifier comprises an identifier for the service provider delivering the data.

13. A method as claimed in claim 1, wherein the service provider further stores a second connection address, for a further communications device of the user, with service data being instead delivered to said further communications device if the service provider is unable to deliver it to said portable communications device.

14. A method as claimed in claim 13, wherein the second connection address is an e-mail address.

15. Apparatus for the delivery of service data to the user of a portable communications device, comprising:
said portable communications device to be carried by said user;
a trigger device having a wireless-discoverable identity and also to be carried by said user;
a service provider data storage and retrieval system including a store of service data and communications means operable to connect to said portable communications device, wherein said trigger device identity is registered at a service provider, together with a connection address for the portable communications device of that user; and
a distributed arrangement of detector devices operable to communicate with said service provider data storage and retrieval system, arranged to detect trigger device identities and to report with identification of the trigger device location to the service provider system, wherein said service provider system is arranged to select from store and deliver service data to the portable communications device of the user, with the selection being made at least partially in dependence on the users location.

16. Apparatus as claimed in claim 15, wherein said detector devices are connected to said service provider system via a data network.

17. Apparatus as claimed in claim 15, wherein the service provider is operable to deliver data to a users portable communications device in two or more forms, with the form for delivery being selected in dependence on the users location as determined by the detector device detecting the users trigger device.

18. A trigger device for use as a part of the apparatus according to claim 15, including storage means holding a unique identifier and being configured for wireless discovery of said identifier by said detector devices.

19. A trigger device as claimed in claim 18, including a short range RF transmitter and receiver and being configured to transmit the stored identifier on receipt of a predetermined signal from a detector device.

20. A trigger device as claimed in claim 18, including an infra-red communications facility and being operable to transmit the stored identifier via infra-red link to a suitable receiver on a detector device.

21. A trigger device as claimed in claim 18, being configured as a swipe card, wherein one or more detector devices have a suitably configured card reader, and the stored identifier is passed to a detector device on swiping of the card through that detector devices card reader.

22. A trigger device as claimed in claim 18, wherein said storage means hold two or more unique identifiers, and further comprising user operable means for selectively enabling or disabling discovery of each stored identifier by a detector device.

23. A trigger device as claimed in claim 18, further comprising position determining means operable to determine a current location for the trigger device and to pass information identifying the same to a detector device discovering the or each unique stored identifier for that trigger device.

24. A portable communications device for use as a part of the apparatus of claim 15, and having integral therewith said trigger device.

25. A portable communications device as claimed in claim 24, further comprising position determining means operable to determine a location for said portable device, wherein the discovery of the unique identifier includes capture of the portable device determined location by the detector device.
